(19) United States
(12) Patent Application Publication
(10) Pub. No.: US 2006/0274030 A1
(43) Pub. Date: Dec. 7, 2006

(54) Electrophoretic display panel

(75) Inventors: Mark Thomas Johnson, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/568,645

(22) PCT Filed: Aug. 5, 2004
(86) PCT No.: PCT/IB04/51407

§ 371 Date: Feb. 16, 2006

(30) Foreign Application Priority Data
Aug. 22, 2003 (EP) 03103212.1

(51) Int. Cl. G09G 3/34

(52) U.S. Cl. 345/107

(57) ABSTRACT

An electrophoretic display panel and a method for driving an electrophoretic display panel in which to bring an element from a preceding optical state to a grey scale in accordance with the image information Preset pulses and driving (grey scale pulses) are integrated into an integrated series of asymmetric (in respect of V=0) pulses. A more gradual introduction of grey scale is thereby achievable, reducing the suddenness of the transition from one image to another.

The invention relates to an electrophoretic display panel, comprising:
an electrophoretic medium comprising charged particles;
a plurality of picture elements;
electrodes associated with each picture element for receiving a potential difference; and
drive means,
   the drive means being arranged for controlling the potential difference of each of the plurality of picture elements
to be a grey scale potential difference for enabling the particles to occupy the position corresponding to image information.

The invention also relates to a method for driving an electrophoretic display device in which method a grey scale potential difference is to a picture element of the display device after application of a reset potential difference.

The invention further relates to drive means for driving an electrophoretic display panel.

An embodiment of the electrophoretic display panel of the type mentioned in the opening paragraph is described in International Patent Application WO 02/073304.

In the described electrophoretic display panel, each picture element has, during the display of the picture, an appearance determined by the position of the particles. “Grey scale” is to be understood to mean any intermediate state. When the display is a black and white display, “grey scale” indeed relates to a shade of grey, when other types of colored elements are used ‘grey scale’ is to be understood to encompass any intermediate state in between extreme optical states.

When the image information is changed the picture elements are reset. After resetting the grey scales are set by application of a grey scale potential difference.

A disadvantage of the present display is that it exhibits an underdrive effect which lead to inaccurate grey scale reproduction. This underdrive effect occurs, for example, when an initial state of the display device is black and the display is periodically switched between the white and black state. For example, after a dwell time of several seconds, the display device is switched to white by applying a negative field for an interval of 200 ms. In a next subsequent interval no electric field is applied for 200 ms and the display remains white and in a next subsequent interval a positive field is applied for 200 ms and the display is switched to black. The brightness of the display as a response of the first pulse of the series is below the desired maximum brightness, which can be reproduced several pulses later. This underdrive effect will result in a large deviation or error from the desired grey level, in particular when this under drive effect is integrated in the subsequent image transitions. Another disadvantage of the display mentioned above is that image retention from the previous image history exists.

It is an object of the invention to provide a display device of the type mentioned in the opening paragraph which can be applied to improve the reproduction of grey scales.

To this end the drive means are further arranged to control for each picture element the grey scale potential difference for at least a subset of all drive waveforms to be a sequence of potential differences, the potential values in the sequence alternating in sign, wherein the energy in the potential difference (V×t) of one sign is substantially more than the energy of potential differences of the other sign.

The invention is based on the following insights:

Application of an alternating sequence of potential differences of equal strength (hereinbelow also called “preset potentials”) reduces the dependency of the appearances of the picture elements on the history of the potential difference and reduces the time needed for application of the grey scale. When applying a preset potential difference, the preset signal comprises a pulse with an energy sufficient to release the electrophoretic particle from a static state at one of the two electrodes, but too low too reach the other one of the electrodes, the underdrive effect is reduced. Because of the reduced underdrive effect the optical response to an identical data signal will be substantially equal, regardless of the history of the display device and in particular its dwell time. The underlying mechanism can be explained because after the display device is switched to a predetermined state e.g. a black state, the electrophoretic particles become in a static state, when a subsequent switching is to the white state, a momentum of the particles is low because their starting speed is close to zero. This results in a long switching time. The application of the preset pulses increases the momentum of the electrophoretic particles and thus shortens the switching time. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time. This process is hereinbelow sometimes also called “shaking up”. However, as the inventors have realized, when a sequence of potential differences of equal strength is applied prior to application of the grey scale difference potential, although apparently showing no optical effect, such application has a positive (as explained above) as well as a detrimental influence on the perceived image update, since the preset signals appear as a delay. This not only increases the total update time, but spoils the natural image update flow by introducing an abrupt stop of the changing image. As the shaking becomes longer (to reduce image retention even more), these problems become more serious. In a device in accordance with the invention a sequence of alternating potential differences is used, after the reset, wherein the energy in the potential difference (V×t) of one sign is substantially more than the energy of potential differences of the other sign. In a device and method in accordance with the invention preset signals (alternating signals of relatively small energy having an average potential of substantially zero, i.e. substantially symmetrical around zero Volt to “shake up” the particles) and the grey scale difference pulse (a pulse of substantially positive or negative sign to bring the particles to a specific position (grey scale) are intertwined, i.e. integrated into a sequence of alternating pulses, wherein a asymmetry is present, i.e. the energy of the pulses of one sign is substantially greater than the energy (energy being herein defined as the product of voltage difference and time) in the pulses of opposite sign. The alternating character of the sequence provides the “shaking effect” reducing image retention, the asymmetry allows the particles to migrate to the desired position, i.e. to attain the grey scale, whereas the integration of the signals allows the image change-over to begin immediately or shortly after the reset, reducing the above mentioned negative optical effect of a prolongation of the change-over and a sudden “jerky” image transition.

The transition to a grey level equivalent to or very close to an extreme optical state, or more in general equivalent to or very close to a preceding optical state, may, within the concept of the invention, still be applied in one short grey scale pulse, preceded by preset pulse(s), as long as for the transition to at least one intermediate grey scale, and preferably to the majority of grey scales from a preceding optical state preset and grey scale pulse preset and grey scale pulses are integrated. Preferably for all transitions having a total grey scale application time longer than a lower threshold two or more pulses are used. Application of the grey scale pulse is often bound by fixed time periods e.g. the frame time periods and there is a maximum to the number of frame time periods (e.g. N, wherein N is 8-16). Transitions requiring very short total pulse (0, 1 or possibly 2 times the fixed or frame time period) may be done in one uninterrupted (by shaking pulses) pulse. At least for a subset of all drive waveforms, wherein drive waveforms stands for the form of the drive pulse to bring an element from one optical state to a grey level optical state, the preset and grey level pulse are integrated. The word “subset” is used to indicate that not necessarily, within the concept of the invention, for each and every application of grey scale potential difference the grey scale and preset pulse need to be integrated.

Preferably the drive means are further arranged for controlling the potential difference of each of the plurality of picture elements to be a reset potential difference having a reset value and a reset duration during a reset period prior to application of the grey scale potential differences. The position of the particles depends not only on the latest applied potential difference(s) but also on the history of the potential difference(s). As a result of the application of the reset potential difference the dependency of the appearance of the picture element on the history is reduced, because particles substantially occupy one of the extreme positions before a grey scale potential difference is applied. Thus the picture elements are each time reset to one of the extreme states. Subsequently, as a consequence of the application of the combined preset-grey scale potential difference(s), the particles occupy the position to display the grey scale corresponding to the image information.

The invention is particularly suitable for use in devices in which reset pulses are used. Reset pulses, although they have a positive effect, lengthen the update time. Any delay becomes then even more noticeable. The smoothing effect of the present invention has thus a relatively great effect when reset pulses are used.

In accordance with the present invention, there is provided a method for driving an electrophoretic display device comprising:

an electrophoretic medium comprising charged particles;

a plurality of picture elements, in which method the grey scale potential differences for at least a subset of all drive waveforms for setting a picture element to a greyscale optical state is applied in a sequence of potential differences, the potential values in the sequence alternating in sign, wherein the energy in the potential difference (V×t) of one sign is substantially more than the energy of potential differences of the other sign.

Also in accordance with the present invention, there is provided drive means for driving an electrophoretic display panel, said display panel comprising:

an electrophoretic medium comprising charged particles;

a plurality of picture elements;

electrodes associated with each picture element for receiving a potential difference; said drive means being arranged for controlling the potential difference of each picture element to be a grey scale potential difference for enabling the particles to occupy the position corresponding to the image information,

said drive means being further arranged to control for each picture element the grey scale potential difference for at least a subset of all drive waveforms to be a sequence of potential differences, the potential values in the sequence alternating in sign, wherein the energy in the potential difference (V×t) of one sign is substantially more than the energy of potential differences of the other sign.

Although the invention has been described for a display panel comprising a plurality of picture elements, it is clear for the man skilled in the art that the invention can also be used for a display panel comprising a single picture element, for instance in signage applications.

These and other aspects of the display panel of the invention will be further elucidated and described with reference to the drawings, in which:

FIG. 1 shows diagrammatically a front view of an embodiment of the display panel;

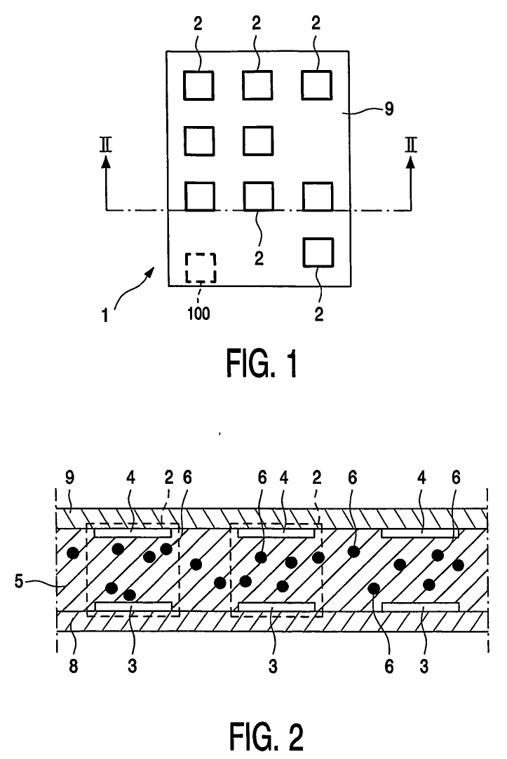

FIG. 2 shows diagrammatically a cross-sectional view along II-II in FIG. 1;

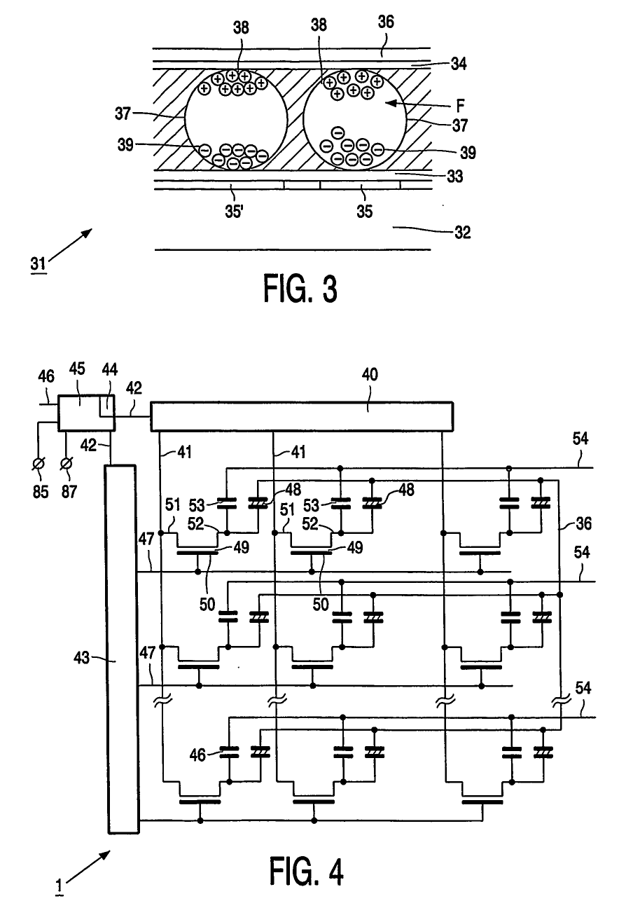

FIG. 3 shows diagrammatically a cross section of a portion of a further example of an electrophoretic display device;

FIG. 4 shows diagrammatically an equivalent circuit of a picture display device of FIG. 3;

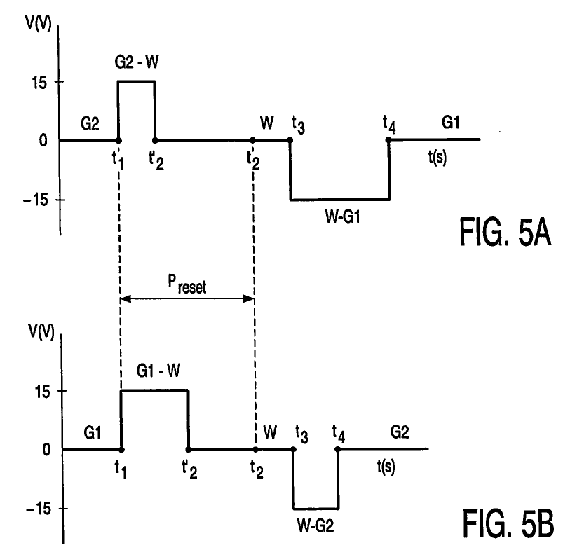

FIG. 5A shows diagrammatically the potential difference as a function of time for a picture element;

FIG. 5B shows diagrammatically the potential difference as a function of time for a picture element;

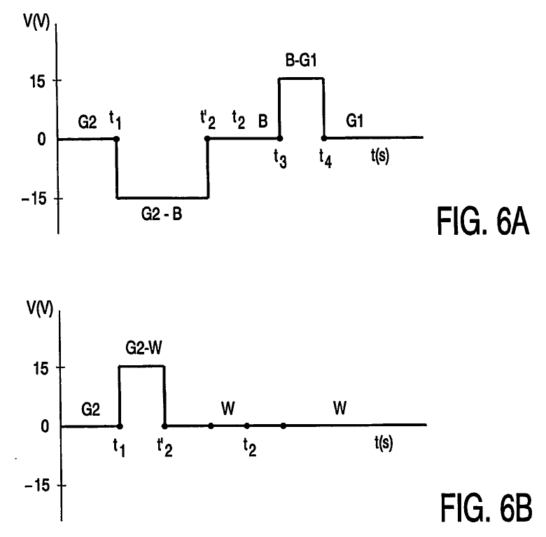

FIG. 6A shows diagrammatically the potential difference as a function of time for a picture element;

FIG. 6B shows diagrammatically the potential difference as a function of time for another picture element of the embodiment associated with FIG. 5A;

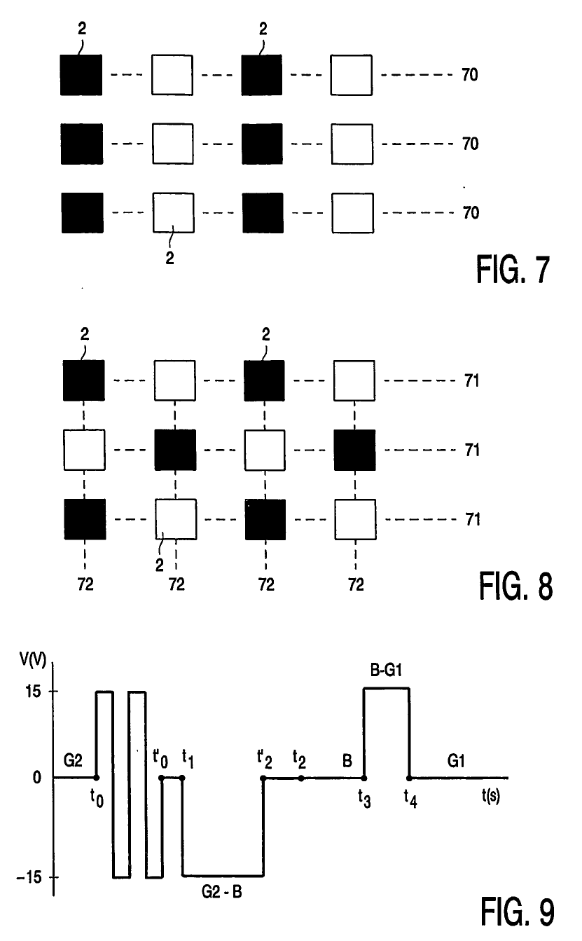

FIG. 7 shows the picture representing an average of the first and the second appearances as a result of the reset potential differences;

FIG. 8 shows the picture representing an average of the first and the second appearances as a result of the reset potential differences in another scheme;

FIG. 9 shows diagrammatically the potential difference as a function of time for a picture element;

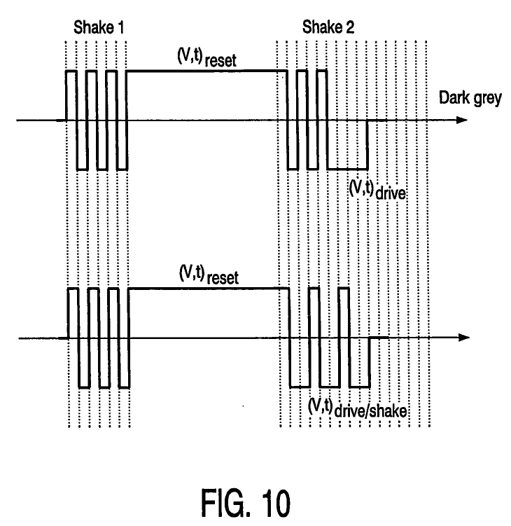

FIG. 10 illustrates driving schemes in accordance with the invention;

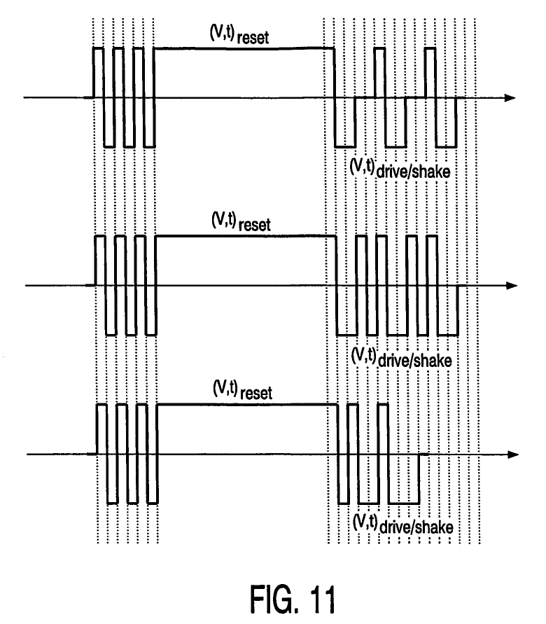

FIG. 11 illustrates further driving schemes in accordance with the invention;

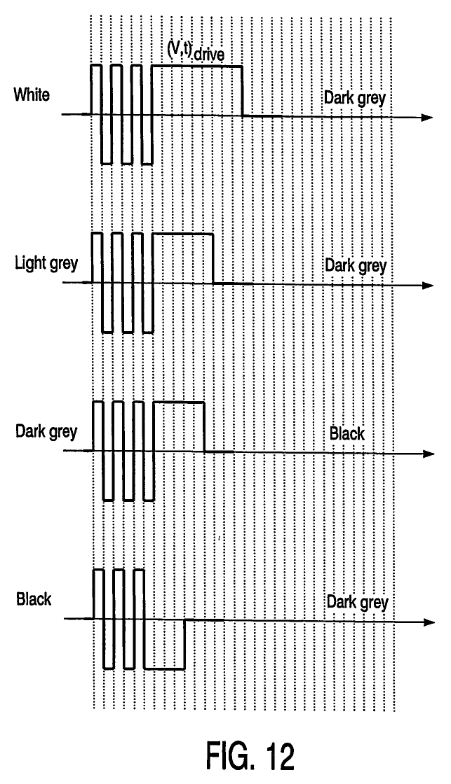

FIG. 12 illustrates driving schemes outside the scope of the invention without the use of reset pulses; and

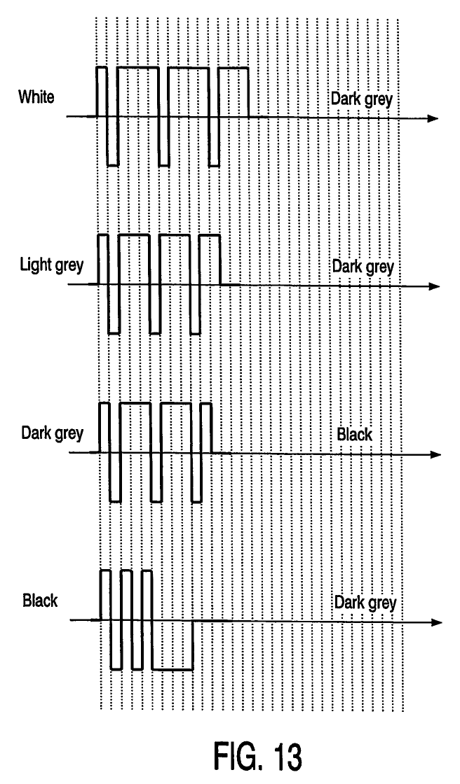

FIG. 13 illustrates driving schemes in accordance with the invention without the use of reset pulses.

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8,9. A first and a second electrode 3,4 are associated with each picture element 2. The electrodes 3, 4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4 for displaying the picture. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are arranged for controlling the potential difference of each picture element 2 to be a reset potential difference having a reset value and a reset duration for enabling particles 6 to substantially occupy one of the extreme positions, and subsequently to be a grey scale potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are hidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remain in the acquired state and the display exhibits a bi-stable character and consumes substantially no power.

FIG. 4 shows diagrammatically an equivalent circuit of a picture display device 31 comprising an electrophoretic film laminated on a base substrate 32 provided with active switching elements, a row driver 43 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 43 consecutively selects the row electrodes 47, while a column driver 40 provides a data signal to the column electrode 41. Preferably, a processor 45 firstly processes incoming data 46 into the data signals. Mutual synchronization between the column driver 40 and the row driver 43 takes place via drive lines 42. Select signals from the row driver 43 select the pixel electrodes via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element. In this embodiment, the additional capacitor 53 is connected to one or more storage capacitor lines 54. Instead of TFT other switching elements can be applied such as diodes, MIM's, etc.

As an example the appearance of a picture element of a subset is light gray, denoted as G2, before application of the reset potential difference. Furthermore, the picture appearance corresponding to the image information of the same picture element is dark gray, denoted as G1. For this example, the potential difference of the picture element is shown as a function of time in FIG. 5A. The reset potential difference has e.g. a value of 15 Volts and is present from time t₁ to time t′₂, t₂ being the maximum reset duration, i.e. the reset period Preset. The reset duration and the maximum reset duration e.g. 50 ms and 300 ms, respectively. As a result, after application of the reset potential, the picture element has an appearance being substantially white, denoted as W. The grey scale potential difference is present from time t₃ to time t₄ and has a value of e.g. −15 Volts and a duration of e.g. 150 ms. As a result the picture element has, after application of the grey scale potential difference, an appearance being dark gray (G1), for displaying the picture. The interval from time t2 to time t3 may be absent.

The maximum reset duration, i.e. the complete reset period, for each picture element of the subset is substantially equal to or more than to the duration to change the position of particles 6 of the respective picture element from one of the extreme positions to the other one of the extreme positions. For the picture element in the example the reference duration is e.g. 300 ms.

As a further example the potential difference of a picture element is shown as a function of time in FIG. 5B. The appearance of the picture element is dark gray (G1) before application of the reset potential difference. Furthermore, the picture appearance corresponding to the image information of the picture element is light gray (G2). The reset potential difference has e.g. a value of 15 Volts and is present from time t₁ to time t′₂. The reset duration is e.g. 150 ms. As a result the picture element has, after application of the reset potential difference, an appearance being substantially white (W). The grey scale potential difference is present from time t₃ to time t₄ and has e.g. a value of e.g. −15 Volts and a duration of e.g. 50 ms. As a result, after application of the grey scale potential difference, the picture element has an appearance being light gray (G2), for displaying the picture.

In another variation of the embodiment the drive means 100 are further arranged for controlling the reset potential difference of each picture element to enable particles 6 to occupy the extreme position which is closest to the position of the particles 6 which corresponds to the image information. As an example the appearance of a picture element is light gray (G2) before application of the reset potential difference. Furthermore, the picture appearance corresponding to the image information of the picture element is dark gray (G1). For this example, the potential difference of the picture element is shown as a function of time in FIG. 6A. The reset potential difference has e.g. a value of −15 Volts and is present from time t₁ to time t′₂. The reset duration is e.g. 150 ms. As a result, the particles 6 occupy the second extreme position and the picture element has a substantially black appearance, denoted as B, which is closest to the position of the particles 6 which corresponds to the image information, i.e. the picture element 2 having a dark gray appearance (G1). The grey scale potential difference is present from time t3 to time t4 and has e.g. a value of e.g. 15 Volts and a duration of e.g. 50 ms. As a result the picture element 2 has an appearance being dark gray (G1), for displaying the picture. As another example the appearance of another picture element is light gray (G2) before application of the reset potential difference. Furthermore, the picture appearance corresponding to the image information of this picture element is substantially white (W). For this example, the potential difference of the picture element is shown as a function of time in FIG. 6B. The reset potential difference has e.g. a value of 15 Volts and is present from time t₁ to time t′₂. The reset duration is e.g. 50 ms. As a result, the particles 6 occupy the first extreme position and the picture element has a substantially white appearance (W), which is closest to the position of the particles 6, which corresponds to the image information, i.e. the picture element 2 having a substantially white appearance. The grey scale potential difference is present from time t₃ to time t₄ and has a value of 0 Volts because the appearance is already substantially white, for displaying the picture.

In FIG. 7 the picture elements are arranged along substantially straight lines 70. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each line 70 to enable particles 6 to substantially occupy unequal extreme positions. FIG. 7 shows the picture representing an average of the first and the second appearances as a result of the reset potential differences. The picture represents substantially middle gray.

In FIG. 8 the picture elements 2 are arranged along substantially straight rows 71 and along substantially straight columns 72 being substantially perpendicular to the rows in a two-dimensional structure, each row 71 having a predetermined first number of picture elements, e.g. 4 in FIG. 8, each column 72 having a predetermined second number of picture elements, e.g. 3 in FIG. 8. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along on each row 71 to enable particles 6 to substantially occupy unequal extreme positions, and the drive means are further arranged for controlling the reset potential differences of subsequent picture elements 2 along on each column 72 to enable particles 6 to substantially occupy unequal extreme positions. FIG. 8 shows the picture representing an average of the first and the second appearances as a result of the reset potential differences. The picture represents substantially middle gray, which is somewhat smoother compared to the previous embodiment.

As explained above, the accuracy of the greyscales in electrophoretic displays is strongly influenced by image history, dwell time, temperature, humidity, lateral inhomogeneity of the electrophoretic foils etc. Using reset pulses accurate grey levels can be achieved since the grey levels are always achieved either from reference black (B) or from reference white state (W) (the two extreme states).

A disadvantage of the present display is that it exhibits an underdrive effect which lead to inaccurate grey scale reproduction. This underdrive effect occurs, for example, when an initial state of the display device is black and the display is periodically switched between the white and black state. For example, after a dwell time of several seconds, the display device is switched to white by applying a negative field for an interval of 200 ms. In a next subsequent interval no electric field is applied for 200 ms and the display remains white and in a next subsequent interval a positive field is applied for 200 ms and the display is switched to black. The brightness of the display as a response of the first pulse of the series is below the desired maximum brightness, which can be reproduced several pulses later. This underdrive effect will result in a large deviation or error from the desired grey level, in particular when this under drive effect is integrated in the subsequent image transitions. Another disadvantage of the display mentioned above is that image retention from the previous image history exists.

One way of reducing this effect is to arrange the drive means for controlling the potential difference of each picture element to be a sequence of preset potential differences before being the reset potential difference and/or before being the grey scale potential differences. In a simple scheme the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. As an example the appearance of a picture element is light gray before the application of the sequence of preset potential differences. Furthermore, the picture appearance corresponding to the image information of the picture element is dark gray. For this example, the potential difference of the picture element is shown as a function of time in FIG. 9. In the example, the sequence of preset potential differences has 4 preset values, subsequently 15 Volts, −15 Volts, 15 Volts and −15 Volts, applied from time t₀ to time t′₀. Each preset value is applied for e.g. 20 ms. The time interval between t′₀ and t₁ is preferably relatively small. Subsequently, the reset potential difference has e.g. a value of −15 Volts and is present from time t₁ to time t′₂. The reset duration is e.g. 150 ms. As a result, the particles 6 occupy the second extreme position and the picture element has a substantially black appearance. The grey scale potential difference is present from time t₃ to time t₄ and has e.g. a value of e.g. 15 Volts and a duration of e.g. 50 ms. As a result the picture element 2 has an appearance being dark gray, for displaying the picture. Without being bound to a particular explanation for the mechanism underlying the positive effects of application of the preset pulses, it is presumed that the application of the preset pulses increases the momentum of the electrophoretic particles and thus shortens the switching time, i.e. the time necessary to accomplish a switch/over, i.e. a change in appearance. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

Although, as the inventors have realized application of preset pulses has a positive effect, there is also a negative effect when the preset pulses are applied in between the reset pulse and the grey scale pulse (shown in FIG. 10 upper part as “shake 2”). The second shaking pulses (before driving), whilst also apparently showing no optical effect, have a detrimental influence on the perceived image update, as they appear as a delay between resetting and driving. This not only increases the total update time, but spoils the natural image update flow by introducing an abrupt stop of the changing image. As the shaking becomes longer (to educe image retention even more), these problems become more serious.

The present invention aims to improve image reproduction without this effect, or at least reducing this effect.

To this end the device in accordance with the invention is characterized in that the drive means are further able to control for each picture element the grey scale potential difference to be a sequence of potential differences, the potential values in the sequence alternating in sign, wherein the energy in the potential difference (V×t) of one sign is substantially more than the energy of potential differences of the other sign.

The method in accordance with the invention is characterized in that for each picture element the grey scale potential difference is applied as a sequence of potential differences, the potential values in the sequence alternating in sign, wherein the energy in the potential difference (V×t) of one sign is substantially more than the energy of potential differences of the other sign.

In a device and method in accordance with the invention preset signals (alternating signals of relatively small energy having an average potential of substantially zero, i.e. substantially symmetrical around zero Volt to “shake up” the particles) and the grey scale difference pulse (a pulse of substantially positive or negative sign to bring the particles to a specific position (grey scale) are intertwined, i.e. integrated into a sequence of alternating pulses, wherein a asymmetry is present, i.e. the energy of the pulses of one sign is substantially greater than the energy (energy being herein defined as the product of voltage difference and time (V×t)) in the pulses of opposite sign. The alternating character of the sequence provides the “shaking effect” reducing image retention, the asymmetry allows the particles to migrate to the desired position, i.e. to attain the grey scale, whereas the integration of the signals allows the image changeover the begin immediately or shortly after the reset, reducing the above mentioned negative optical effect of an prolongation of the change over and a sudden “jerky” image transition.

The invention will be further exemplified with reference to FIGS. 10 and 11.

In the invention disclosure, a series of driving methods and device in which these driving method are incorporated are provided whereby the delay in the image update between resetting and driving (=introduction of grey scale) is eliminated, or at least strongly reduced, whilst still allowing the use of shaking pulses (preset pulses) to reduce the image retention problems. This is achieved by integrating the (distributed) driving pulses into the shaking pulse, whereby an asymmetric shaking pulse form results. In this way, the greyscales are directly introduced into the image after resetting.

Several examples will be given with reference to FIGS. 10 and 11.

### EMBODIMENT 1

### Integrated Shaking and Periodic Distributed Drive Pulses

The upper part of FIG. 10 shows a scheme in which a single grey scale pulse is preceded by a series of preset pulses. Such a scheme falls outside the scope of the invention since preset pulses and a single grey scale pulse are applied separately and consecutively, i.e. one after the other. In embodiment 1 (bottom part of FIG. 10), the invention is implemented by incorporating a regularly spaced series of drive pulses of fixed magnitude and time into the shaking pulse. An example for the transition from white to dark grey is shown in FIG. 10 (bottom half of the figure). As explained above the upper half of FIG. 10 illustrates, for comparison, a driving scheme in which preset (shaking) pulses are separated from and precede the single driving pulse, thus showing a driving scheme outside the scope of the present invention. For the transition from white to dark grey a positive reset pulse is used to set the display to the black state, from where the dark grey level is immediately added using a short periodic negative pulse superimposed upon the shaking pulse. As a consequence, the combined drive/shaking pulse [(V,t)drive/shake] appears in the form of an asymmetric sequence of alternating pulses.

For an ideal ink material, the grey scale realized after this series of pulses is identical to that of the prior art, as the product of (voltage×time) for the total drive pulse is equivalent in both cases. For this reason, the total image update time is the same length, but the image update appears more natural as the delay during “shake 2” has been eliminated. For non-ideal ink (with dwell time problems etc.) it may be necessary to slightly adjust the total drive time (i.e. adjust the additional number of negative voltage pulses) to realize the required grey scale.

### EMBODIMENT 2

### Slower Update Using Integrated Shaking and Periodic Distributed Drive Pulses

In certain situations, it may be preferred to intentionally increase the drive period (for example if this results in a more natural image update situation). This is however only acceptable if there is no long delay in the update between reset and driving pulses. In embodiment 2, an intentionally slower update is implemented by incorporating a regularly spaced series of drive pulses and short delay pulses (V=0) of fixed magnitude and time into the shaking pulse. An example for the transition from white to dark grey is shown in FIG. 11 (top). For the transition from white to dark grey a positive reset pulse is used to set the display to the black state, from where the dark grey level is again immediately added using a short periodic negative pulse superimposed upon the shaking pulse. The image update is made intentionally slower by adding 2 frames with V=0 between each asymmetric shaking pulse. Again, for non-ideal ink (with dwell time problems etc.) it may be necessary to slightly adjust the total drive time (i.e. adjust the additional number of negative voltage pulses) to realize the required grey scale. In the time interval between two subsequent shaking pulses, the voltage level is substantially zero. However, it is not excluded that a non-zero voltage level is applied in the time period as long as the voltage level is below the threshold voltage of the display material, i.e. the particles would not move under the influence of this voltage level. This may occur when the source driver output is not ideally zero or when one wants to make use of this time period for other purposes such as dc-balancing.

It has been found that the image retention reduces as the total amount of shaking is increased. In this case, if an intentionally slower update is to be implemented, a preferred method of implementation is to replace the short delay pulses with further shaking pulses, resulting in the combined shake/drive waveform of FIG. 11 (middle curve, embodiment 2a). This will result in still lower image retention, but the same natural image update effect as in embodiment 2. Embodiment 2 is illustrated in the upper most part of FIG. 11. Embodiment 2a in the middle of FIG. 11.

### EMBODIMENT 3

### Integrated Shaking and Distributed Drive Pulses with Irregular Duration

In embodiment 3, this invention is implemented by incorporating a series of drive pulses of fixed magnitude and irregular duration into the shaking pulse. An example for the transition from white to dark grey is shown in FIG. 11 (bottom). Again, for the transition from white to dark grey a positive reset pulse is used to set the display to the black state. For actual inks (with dwell time problems etc.), it has been found that the grey scale accuracy and image retention are improved if the pixel is first shaken before the driving pulses are applied. To achieve this without an unacceptable delay, we propose to introduce the dark grey levels almost immediately after the reset by using a series of negative pulses with irregular duration superimposed upon the shaking pulse. As a consequence, the combined drive/shaking pulse [(V,t)drive/shake] appears in the form of an asymmetric shaking with progressively longer negative pulses. In this way, the pulse form changes gradually from a “shaking” type to a “driving” type towards the end of the waveform.

Embodiment 2a and embodiment 3 each comprise in the integrated drive-shaking pulse a subsequence of potential differences, the potential values in the sequence alternating in sign, wherein the energy in the potential difference (V.t) of one sign is substantially the same as the energy in potential difference of the opposite sign, embodiment 2a comprising an intermediate subsequence, i.e. it occurs somewhere during the integrated shaking-drive pulse, while in embodiment 3 the subsequence is an initial subsequence.

When expressed in strength (i.e. voltages times application times) the sequence of FIG. 10 upper part may be described as:

1,−1,1,−1,1,−1, −3, i.e. a symmetric sequence (1,−1,1,−1,1,−1) followed by a pulse (−3) of one only one sign, i.e. non-alternating. Such sequences, i.e. sequences consisting of a symmetric pulse sequence, followed by a pulse or sequence of pulses of only one sign, does not fall under the scope of the invention.

The sequence of FIG. 10, bottom part may be described as 1,−2,1,−2,1,−2, i.e. an asymmetric sequence, wherein the total negative values outweighs the positive values by e.g. 3 frame time.

The sequences of FIG. 11 may be described as:

Upper part: 1,−2,0,1,−2,0,1,−2, i.e. an asymmetric sequence

Middle part: 1,−2,1,−1,1,−2,1,−1,1,−2, i.e. an asymmetric sequence having intermediate symmetric subsequences

Lower part: 1,−1,1,−2,1,−2, i.e. an asymmetric sequence having an initial symmetric subsequences

It is remarked, see upper part of FIG. 11, that the combined shaking/grey scale pulse may, and in preferred embodiments does, comprise time intervals in which the applied voltage may be substantially zero or a voltage value below a threshold voltage value below which the particle(s) remain substantially in their position.

It is remarked that, within the concept of the invention the application of reset potential difference may encompass, and in preferred embodiments does encompass, the application of overresetting. “Overresetting stands for methods of application of reset potentials in which purposively, at least for the transition of some grey scale state (intermediate states) reset pulses are applied which have a longer time×voltage difference than needed to drive the relevant element to the desired extreme optical state. Such overresetting may be usefull to ensure that an extreme optical state is reached, or it may be used to simplify the application scheme, such that e.g. the same length of resetting pulse is used for the resetting of different grey scale to an extreme optical state.

It is remarked that the amplitude of the shaking pulses needs not have the same amplitude. For example, the use of asymmetric shaking pulses with reduced amplitude or energy (voltage×time) in time would also lead to accurate and smooth greyscale image update. Also, the electrode structure is not limited, structures such as with top and bottom electrode, with honeycomb electrode structures may be used.

In short the invention can be described as an electrophoretic display panel and a method for driving an electrophoretic display panel in which to bring an element from a preceding optical state to a grey scale in accordance with the image information preset pulses and driving (grey scale pulses) are integrated into an integrated series of asymmetric (in respect of V=0) pulses. A more gradual introduction of grey scale is thereby achievable, reducing the suddenness of the transition from one image to another.

It will be appreciated by persons skilled in the art that the present invention is not limited by what has been particularly shown and described hereinabove.

For instance, in all the examples given above the preceding optical state is an extreme optical state, due to the fact that prior to application of the combined preset-grey scale potential difference, reset pulses are applied bringing the element(s) to an extreme optical state (black or white).

The invention is particularly suitable for such devices, but not restricted to devices and method and driving schemes in which use is made of reset pulses. The invention relates to the application of grey scale pulses in two or more sub-pulses separated by time intervals.

As an illustration of devices, methods and driving schemes not using reset pulses FIG. 12 illustrates driving schemes in which for the transition of a grey scale to another grey scale single drive pulse is used. The initial (starting) optical position (i.e. grey scale, e.g. white, black, light grey dark grey) is given at the left hand side of the figure. The driving pulse is schematically given and at the right hand side the resulting grey scale is given.

In the example of FIG. 12 a simple grey scale pulse is applied, preceded by preset pulses, thus this figure illustrates a driving scheme outside the scope of the invention. Preset and grey scale pulses are not combined into an asymmetric series of pulses, but rather the preset pulse is a series of short pulses, followed by a single continuous grey scale pulse.

FIG. 13 illustrates driving schemes within the scope of the invention. As in FIG. 12, the left hand side gives the initial optical state, the right hand side the final optical state, and the driving pulses are illustrated in between the left and right hand side. In these examples the grey scale pulse (V,t)drive is applied in an asymmetric series of pulses wherein the energy in pulses of one sign (the positive sign in this case) is larger then the energy in pulses of the opposite sign. The bottom part of the figure illustrates a situation as already explained above in which for the transition from one optical state (black) to a close optical state (dark grey) the drive pulse is still one single short pulse. The positive effect of the invention is relatively small when only a small change in grey scale is performed, from black to dark grey in this example, and relatively large when a large difference in appearance is preformed, for instance from white to dark grey, as illustrated in the uppermost part of FIG. 13.

In the schemes illustrated in FIGS. 12 and 13 the preceding optical state, i.e. the optical state of an element immediately preceding application of grey scale potential differences, may be any optical state (black, white, dark grey or light grey), not necessarily an extreme optical state as in FIGS. 10 and 11.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention.

The present invention has been described in terms of specific embodiments, which are illustrative of the invention and not to be construed as limiting. The invention may be implemented in hardware, firmware or software, or in a combination of them. Other embodiments are within the scope of the following claims.

It will be obvious that many variations are possible within the scope of the invention without departing from the scope of the appended claims.

1. An electrophoretic display panel (1), comprising:
an electrophoretic medium (5) comprising charged particles (6);
a plurality of picture elements (2);
electrodes (3,4) associated with each picture element (2) for receiving a potential difference; and
drive means (100),
the drive means (100) being arranged for controlling the potential difference of each picture element (2)
to be a grey scale potential difference for enabling the particles (6) to occupy the position corresponding to the image information,
wherein the drive means (100) are further arranged to control for each picture element the grey scale potential difference for at least a subset of all drive waveforms to be a sequence of potential differences, the potential values in the sequence alternating in sign, wherein the energy in the potential difference (V×t) of one sign is substantially more than the energy of potential differences of the other sign.

2. An electrophoretic display panel (1) as claimed in claim 1, wherein the drive means (100) are arranged for controlling the potential difference of each picture element (2)
to be a reset potential difference having a reset value and a reset duration for enabling particles (6) to substantially occupy one of the extreme positions, prior to the grey scale potential differences.

3. An electrophoretic display panel as claimed in claim 1, characterized in that the grey scale potential difference comprises a symmetric subsequence of potential differences, the potential values in the sequence alternating in sign, wherein the energy in the potential difference (Vxt) of one sign is substantially the same as the energy in potential difference of the opposite sign.

4. An electrophoretic display panel as claimed in claim 3, wherein the symmetric subsequence is an intermediate subsequence.

5. An electrophoretic display panel as claimed in claim 3, wherein the symmetric subsequence is an initial subsequence.

6. An electrophoretic display panel as claimed in claim 1, wherein the sequence of potential differences comprises at least one time interval in which the applied voltage has a voltage value below a threshold voltage value below which the particle(s) remain substantially in their position.

7. A method for driving an electrophoretic display device comprising:
an electrophoretic medium (5) comprising charged particles (6);
a plurality of picture elements (2), in which method the grey scale potential differences for at least a subset of all drive waveforms for setting a picture element to a greyscale optical state is applied in a sequence of potential differences, the potential values in the sequence alternating in sign, wherein the energy in the potential difference (V×t) of one sign is substantially more than the energy of potential differences of the other sign.

8. A method for driving an electrophoretic display device as claimed in claim 7, wherein prior to application of the grey scale potential differences reset potential differences are applied having a reset value and a reset duration for enabling particles (6) to substantially occupy one of the extreme positions.

9. A method as claimed in claim 7, wherein the grey scale potential difference comprises a symmetric subsequence of potential differences, the potential values in the sequence alternating in sign, wherein the energy in the potential difference (V.t) of one sign is substantially the same as the energy in potential difference of the opposite sign.

10. A method as claimed in claim 9, wherein the symmetric subsequence is applied as an intermediate subsequence.

11. A method as claimed in claim 9, wherein the symmetric subsequence is applied as an initial subsequence.

12. A method as claimed in claim 7, wherein the applied sequence of potential differences comprises at least one time interval in which the applied voltage has a voltage value below a threshold voltage value below which the particle(s) remain substantially in their position.

13. Computer program comprising program code means for performing a method in accordance with a method as claimed in claim 7 when said program is run on a computer.

14. Computer program product comprising program code means stored on a computer readable medium for performing a method as claimed in claim 7 when said program is run on a computer.

15. Computer program product comprising program code means for use in display panel as claimed in claim 1, for performing the action specific for said claims.

16. Drive means (100) for driving an electrophoretic display panel (1), said display panel (1), comprising:
an electrophoretic medium (5) comprising charged particles (6);
a plurality of picture elements (2);
electrodes (3,4) associated with each picture element (2) for
receiving a potential difference;
said drive means (100) being arranged for controlling the potential difference of each picture element (2) to be a grey scale potential difference for enabling the particles (6) to occupy the position corresponding to the image information,
said drive means (100) being further arranged to control for each picture element the grey scale potential difference for at least a subset of all drive waveforms to be a sequence of potential differences, the potential values in the sequence alternating in sign, wherein the energy in the potential difference (V×t) of one sign is substantially more than the energy of potential differences of the other sign.
